(19) United States
(12) Patent Application Publication
(10) Pub. No.: US 2017/0156981 A1
(43) Pub. Date: Jun. 8, 2017

(54) EYE WASHING NOZZLE AND EYE WASHING LIQUID CONTAINER

(71) Applicant: MUYU CO., LTD., Tokyo (JP)

(72) Inventor: Hiroshi ITO, Tokyo (JP)

(73) Assignee: MUYU CO., LTD., Tokyo (JP)

(21) Appl. No.: 15/439,505

(22) Filed: Feb. 22, 2017

Related U.S. Application Data
(63) Continuation of application No. PCT/JP2015/067590, filed on Jun. 18, 2015.

(30) Foreign Application Priority Data
Oct. 16, 2014 (JP) 2014-212036

(51) Int. Cl. A61H 35/02; B05B 11/04; B05B 11/00

(52) U.S. Cl. CPC A61H 35/02; B05B 11/001; B05B 11/048; B05B 11/047

(57) ABSTRACT

An eye washing nozzle includes a base portion and a tubular portion and is attached to a container body portion. The base portion is a portion to be fixed to the container body portion. The tubular portion is connected to the base portion. The tubular portion is a portion through which the eye washing liquid passes. The leading end portion of the tubular portion is provided with a discharging port that discharges the eye washing liquid that has passed through the tubular portion.

### CROSS REFERENCE TO RELATED APPLICATION

This is a Continuation of International Application No. PCT/JP2015/067590 filed Jun. 18, 2015, which claims the benefit of Japanese Application No. 2014-212036 filed Oct. 16, 2014. The disclosures of the prior applications are hereby incorporated by reference in their entirely.

### TECHNICAL FIELD

The present invention relates to an eye washing nozzle and an eye washing liquid container used for washing an eye of a human or animal.

### BACKGROUND ART

Patent Literature 1 discloses a container for washing an eye with eye washing liquid. The container disclosed in Patent Literature 1 is a cup-shaped container composed of an elastically-deformable material, and has an edge portion with a shape that comes into close contact with the periphery of the eye.

When an eye is to be washed, eye washing liquid is poured into the container, and thereafter the edge portion of the container is brought into close contact with the periphery of the eye while the face is directed downward. By squeezing a portion of the container while in this state, the eye washing liquid in the container can be stirred and the eye can be washed with the eye washing liquid. Alternatively, the eye can be washed also by bringing the edge portion of the container into close contact with the periphery of the eye and thereafter repeatedly blinking while the face is directed upward.

### CITATION LIST

### Patent Literature

[PLT 1] JP 2014-133025A

### SUMMARY OF INVENTION

### Technical Problem

However, if the eye is to be washed using the container disclosed in Patent Literature 1, the peripheral portion of the eye is covered by the container, and therefore eye washing liquid that has come into contact with the peripheral portion will return to the container. Washing the eye with eye washing liquid that has come into contact with the peripheral portion of the eye in this way is unhygienic. Depending on the case, there is a risk that foreign matter (an eyelash, make-up, dust, pollen, etc.) attached to the peripheral portion of the eye will enter the eye.

### Solution to Problem

The prevent invention has been achieved in view of the foregoing problems, and it is an object of the present invention to provide an eye washing nozzle and an eye washing liquid container with excellent hygienic qualities.

The eye washing nozzle according to the present invention is an eye washing nozzle to be attached to a container body portion for containing eye washing liquid, including: a base portion to be fixed to the container body portion; and a tubular portion that is connected to the base portion and through which the eye washing liquid passes, a leading end portion of the tubular portion being provided with a discharging port for discharging the eye washing liquid that has passed through the tubular portion.

In the eye washing nozzle, the discharging port for discharging the eye washing liquid is provided at the leading end portion of the tubular portion. The eye washing liquid is discharged through the discharging port to the eye, whereby the eye can be washed. For this reason, it is possible to avoid a circumstance in which the eye is washed with eye washing liquid that has come into contact with the peripheral portion of the eye.

Also, the eye washing liquid container according to the present invention includes the eye washing nozzle and the container body portion to which the eye washing nozzle is attached.

The eye washing liquid container is provided with the above-described eye washing nozzle. Accordingly, the eye washing liquid is discharged to the eye through the discharging port of the eye washing nozzle, whereby the eye can be washed. For this reason, it is possible to avoid a circumstance in which the eye is washed with eye washing liquid that has come into contact with the peripheral portion of the eye.

### Advantageous Effects of Invention

According to the present invention, an eye washing nozzle and an eye washing liquid container with excellent hygienic properties are achieved.

### BRIEF DESCRIPTION OF DRAWINGS

FIG. 1 is a perspective view showing a first embodiment of an eye washing liquid container according to the present invention.

FIG. 2 is a perspective view showing an eye washing nozzle 10 in a state of having been removed from a container body portion 20.

FIG. 3 is an end view taken along line III-III in FIG. 2.

FIG. 4 is a perspective view showing the container body portion 20 in a state in which the eye washing nozzle 10 has been removed.

FIG. 5 is a front view showing a state in which eye washing liquid 30 is discharged in the eye washing liquid container shown in FIG. 1.

FIG. 6 is a diagram for describing a method for using the eye washing liquid container shown in FIG. 1.

FIG. 7 is a diagram for describing a method for using the eye washing liquid container shown in FIG. 1.

FIG. 8 is a diagram for describing a method for using the eye washing liquid container shown in FIG. 1.

FIG. 9 is a perspective view showing a second embodiment of an eye washing liquid container according to the present invention.

FIG. 10 is a perspective view showing a third embodiment of an eye washing liquid container according to the present invention.

FIG. 11 is a perspective view showing an eye washing nozzle 50 in a state of having been removed from the container body portion 20.

FIG. 12 is an end view taken along line XII-XII in FIG. 11.

FIG. 13 is a plan view showing a discharging port 56 of the eye washing nozzle 50 shown in FIG. 11.

### DESCRIPTION OF EMBODIMENTS

Hereinafter, embodiments of the present invention will be described in detail with reference to the drawings. Note that in the description of the drawings, like elements are denoted by like reference signs, and redundant description is not included.

### First Embodiment

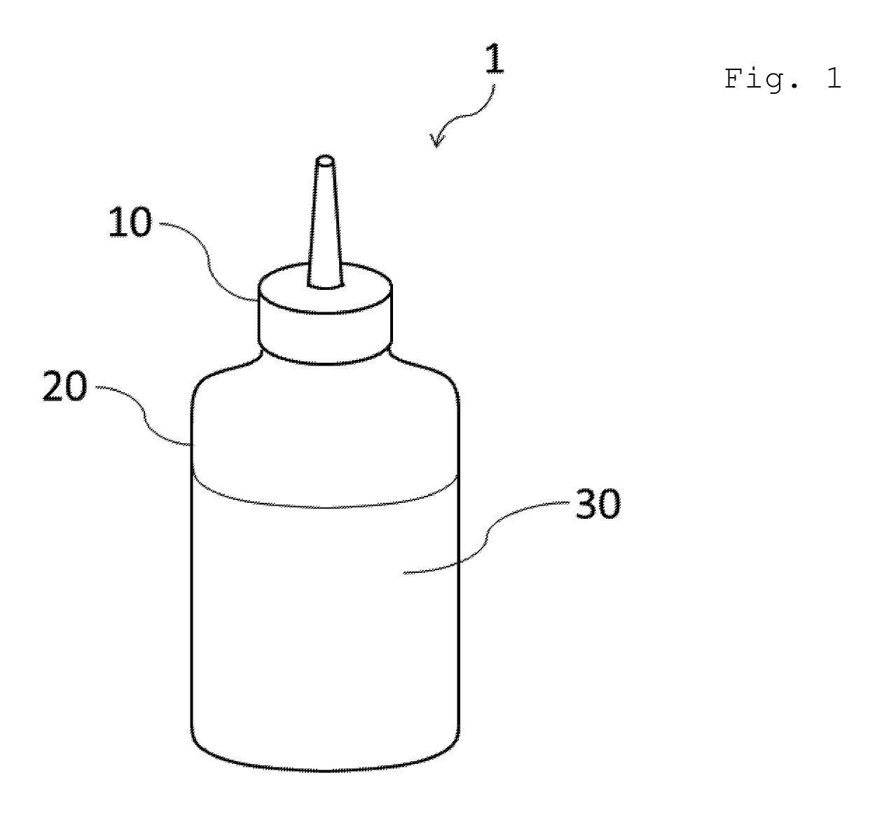

FIG. 1 is a perspective view showing a first embodiment of an eye washing liquid container according to the present invention. An eye washing liquid container 1 includes an eye washing nozzle 10 and a container body portion 20. Eye washing liquid 30 is contained in the container body portion 20. The volume of the container body portion 20 is preferably 50 ml or more. The eye washing liquid container 1 is used when washing an eye of a human or an animal with the eye washing liquid 30.

The eye washing nozzle 10 is attached to the container body portion 20. The eye washing nozzle 10 is detachable from the container body portion 20. Here, being detachable means that attachment and detachment of the eye washing nozzle 10 to and from the container body portion 20 can be performed easily without damaging the eye washing liquid container 1 or using a tool.

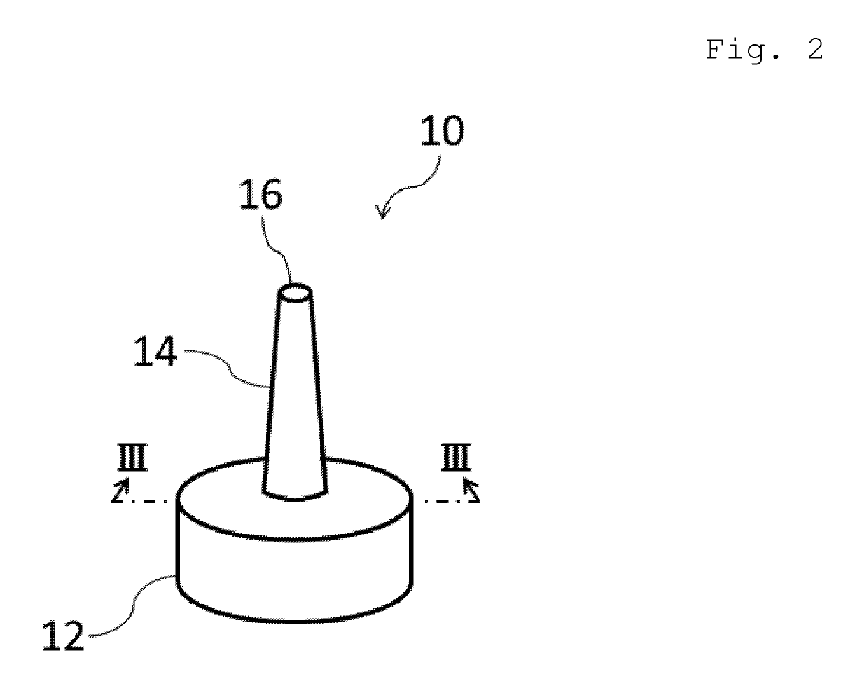

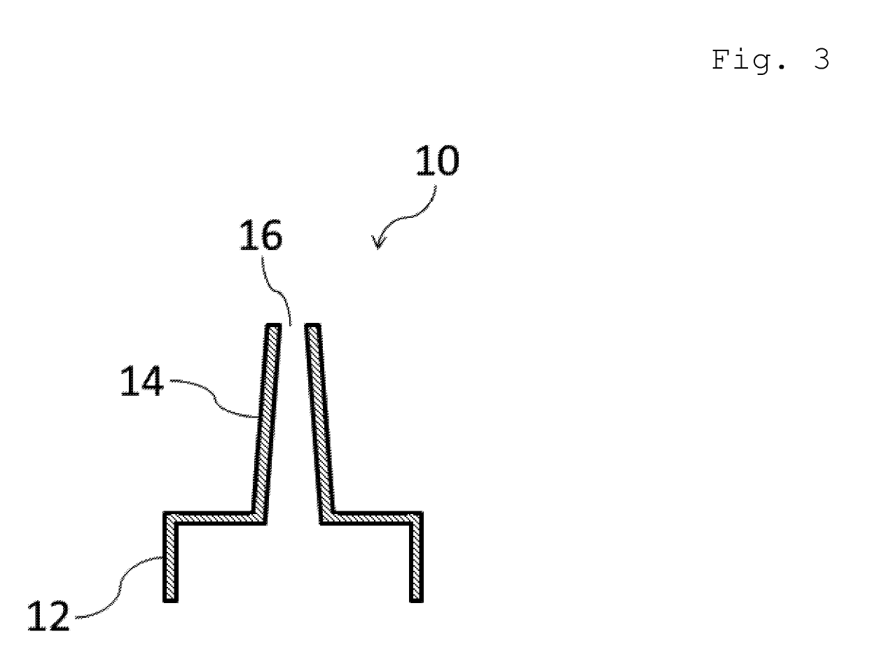

FIG. 2 is a perspective view showing an eye washing nozzle 10 in a state of having been removed from the container body portion 20. Also, FIG. 3 is an end view taken along line III-III in FIG. 2. The eye washing nozzle 10 includes a base portion 12 and a tubular portion 14. The base portion 12 is a portion to be fixed to the container body portion 20. The base portion 12 is ring-shaped. A female screw (not shown) is formed on the inner circumferential surface of the base portion 12. The female screw is formed so as to screw onto a male screw formed on a spout 22 of the later-described container body portion 20.

The tubular portion 14 is connected to the base portion 12. Specifically, the tubular portion 14 extends upward from the base portion 12. The tubular portion 14 is a portion through which the eye washing liquid 30 passes. The leading end portion of the tubular portion 14 is provided with a discharging port 16 for discharging the eye washing liquid 30 that has passed through the tubular portion 14. The tubular portion 14 has a tapered shape with an inner diameter that decreases toward the discharging port 16. A thermoplastic resin such as polyethylene or polypropylene can be used as the material for the eye washing nozzle 10, for example. Note that the eye washing nozzle 10 may be provided with a cap that covers the discharging port 16.

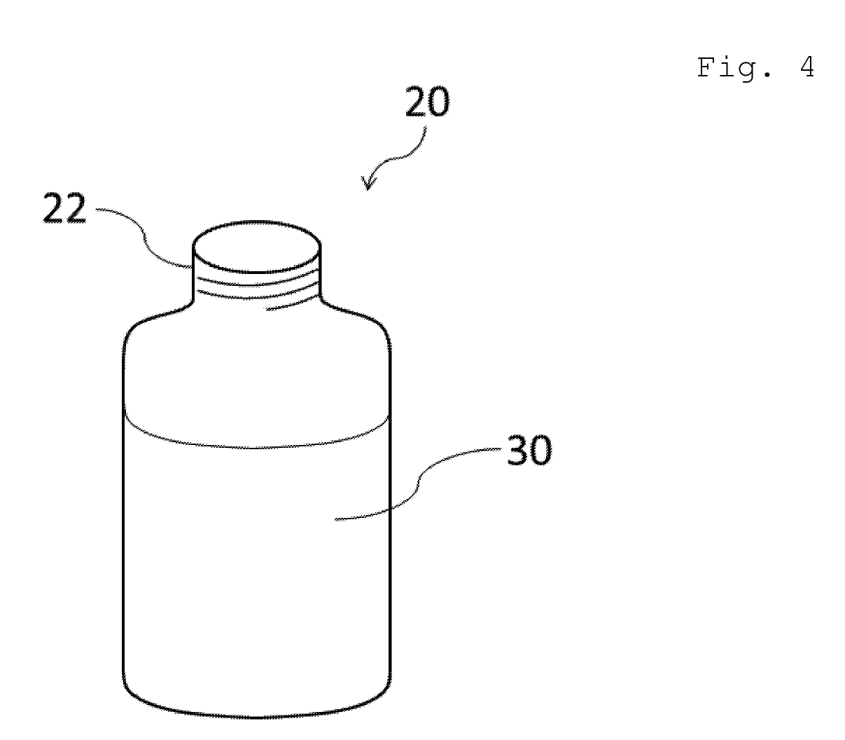

FIG. 4 is a perspective view showing the container body portion 20 in a state in which the eye washing nozzle 10 has been removed. A male screw is formed on the outer circumferential surface of the spout 22 of the container body portion 20. By screwing the female screw of the base portion 12 onto this male screw, the eye washing nozzle 10 can be attached to the container body portion 20. In the present embodiment, the shape and size of the spout 22 is equal to the shape and size of a spout of a common PET bottle body portion for drinking. For this reason, the eye washing nozzle 10 can be attached to and detached from the PET bottle body portion as well. Note that the cross-sectional shape (shape of a cross section orthogonal to the vertical direction at a portion other than the spout 22) of the container body portion 20 is arbitrary, and a circle, an oval, a rectangle, a flat shape, and the like are conceivable examples thereof.

The container body portion 20 is composed of a highly-flexible and highly-elastic material, and is elastically deformable. It is preferable that the container body portion 20 can elastically deform until the opposing side surfaces thereof come into contact with each other. In other words, it is preferable that even if a force is applied with a hand until the opposing side surfaces come into contact with each other, the shape of the container body portion 20 returns to normal when the hand is released. For example, silicone resin, low-density polyethylene, or the like can be used as the material of the container body portion 20.

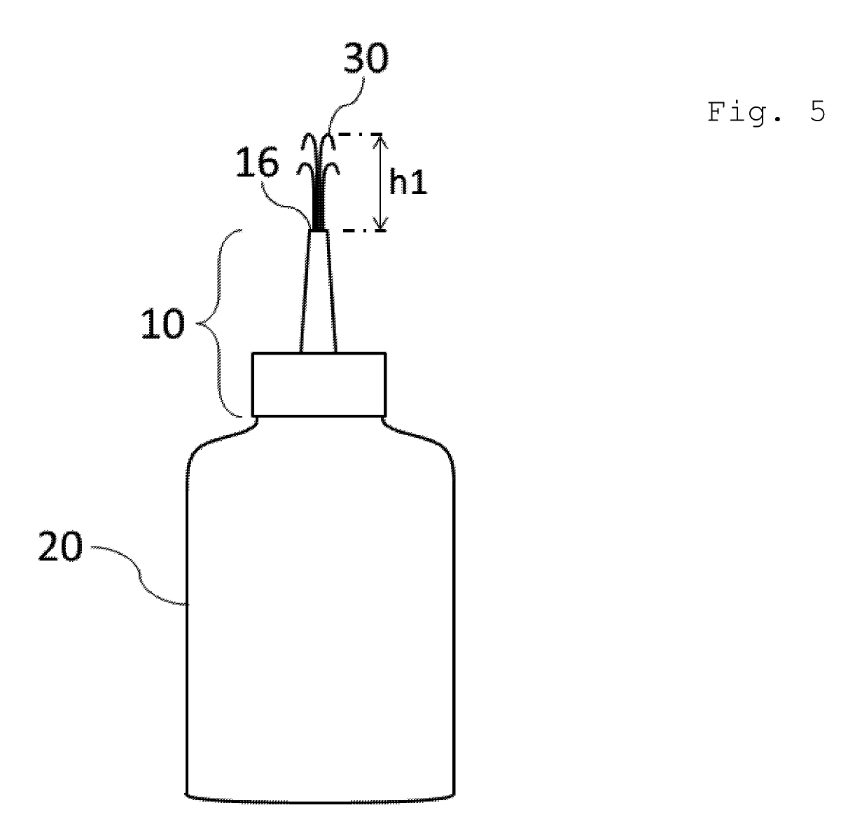

Since the container body portion 20 can elastically deform in this manner, the eye washing liquid 30 can be discharged from the discharging port 16 of the eye washing nozzle 10 due to the container body portion 20 being pressed. At this time, as shown in FIG. 5, it is preferable that the eye washing liquid 30 is discharged up to a height of at least 3 cm from the discharging port 16 when the eye washing nozzle 10 is directed upward. In other words, a height h1 of the highest-reaching point of the eye washing liquid 30 discharged from the discharging port 16 in FIG. 5 is preferably 3 cm or more. Also, the amount of the eye washing liquid 30 discharged from the discharging port 16 in one instance is preferably greater than 0.03 ml and more preferably greater than 0.15 ml. Here, the amount discharged in one instance refers to the amount of eye washing liquid 30 discharged in one instance of pressing.

Effects of the present embodiment will be described here. The eye washing liquid container 1 is provided with the eye washing nozzle 10. In the eye washing nozzle 10, the discharging port 16 for discharging the eye washing liquid 30 is provided at the leading end portion of the tubular portion 14. By discharging the eye washing liquid 30 through the discharging port 16 to the eye, the eye can be washed. For this reason, it is possible to avoid a circumstance in which the eye is washed with eye washing liquid that has come into contact with the peripheral portion of the eye. Accordingly, the eye washing nozzle 10 and the eye washing liquid container 1 with excellent hygienic qualities are achieved.

By contrast, in the case of using the container disclosed in Patent Document 1, there is a problem in terms of the hygienic qualities due to the fact that eye washing liquid that has come into contact with the eye and the peripheral portion thereof returns to the container and due to the fact that the container is used with the edge portion of the container in contact with the face (periphery of the eye). Moreover, the container needs to be washed each time it is used, which is cumbersome. In this regard, according to the present embodiment, the eye washing liquid 30 that is discharged can be prevented from returning to the eye washing nozzle 10 and the container body portion 20, and the eye washing liquid container 1 can be used with the eye washing nozzle 10 located away from the face. For this reason, the eye washing nozzle 10 and the eye washing liquid container 1 can be used hygienically without washing each time it is used.

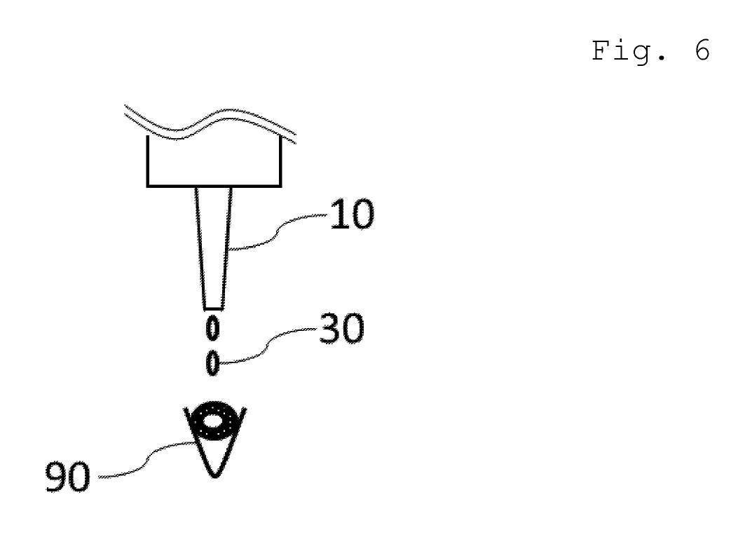

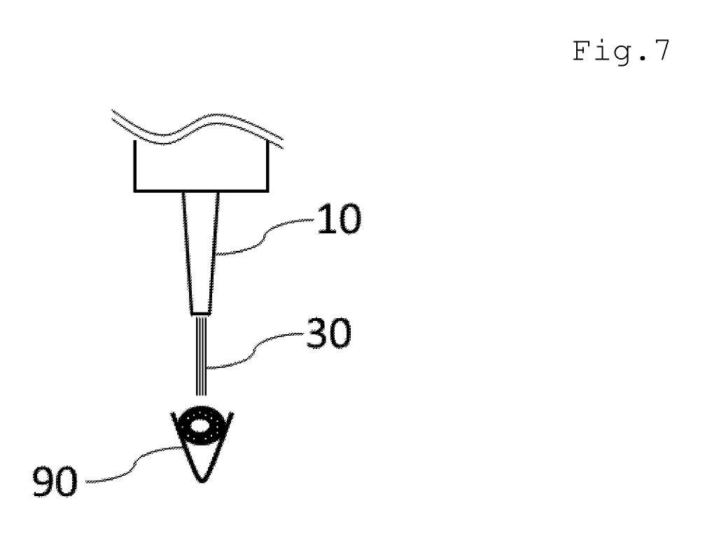

The container body portion 20 is elastically deformable. For this reason, the eye washing liquid 30 can be discharged easily by pressing the container body portion 20 with the hand. Also, by changing the strength of the force of pressing, the degree with which the eye washing liquid 30 is discharged can be adjusted. For example, by pressing with a relatively weak force, the eye washing liquid 30 in the form of drops can be caused to drip into an eye 90, as shown in FIG. 6. Alternatively, by pressing with a relatively strong force, the eye washing liquid 30 that flows continuously can be sprayed on the eye 90, as shown in FIG. 7.

If the container body portion 20 can elastically deform until the opposing side surfaces thereof come into contact with each other, it is possible to cause the container body portion 20 to warp significantly due to pressure. By causing the container body portion 20 to warp significantly in this manner, it is possible to vigorously discharge the eye washing liquid 30 from the discharging port 16 and increase the eye washing effect.

The tubular portion 14 has a tapered shape with an inner diameter that decreases toward the discharging port 16. This structure is also suitable for vigorously discharging the eye washing liquid 30 from the discharging port 16.

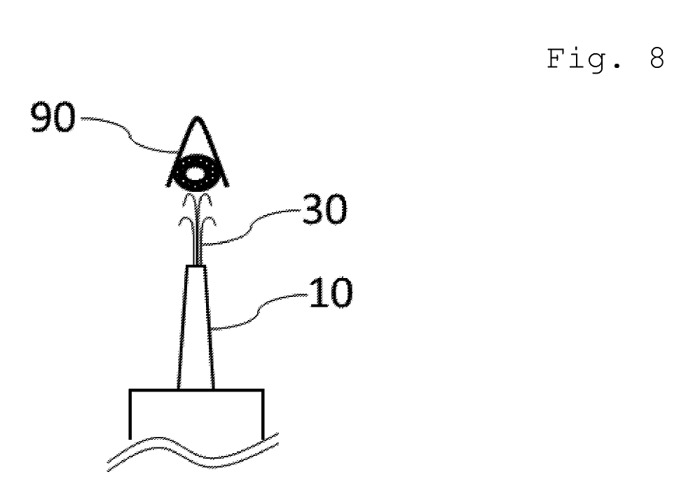

In the case of using a configuration in which the eye washing liquid 30 is discharged up to a height of 3 cm or more from the discharging port 16 of the eye washing nozzle 10 by pressing the container body portion 20, the eye washing liquid container 1 can be used suitably while the eye washing nozzle 10 is directed upward as well. In other words, as shown in FIG. 8, the eye 90 can be washed by spraying the eye washing liquid 30 from below to the eye 90 while the face is directed downward. An eye washing liquid container 1 that can be used in such a way is particularly useful for a user who has trouble with the action of facing upward due to reasons such as the neck being in pain.

In order to sufficiently obtain the eye washing effect of the eye washing liquid 30, a relatively large amount of the eye washing liquid 30 is preferably discharged from the discharging port 16. From this viewpoint, the amount of the eye washing liquid 30 discharged from the discharging port 16 in one instance is preferably greater than 0.03 ml and more preferably greater than 0.15 ml.

The eye washing nozzle 10 is detachable from the container body portion 20. For this reason, the eye washing liquid 30 can be easily replenished in the container body portion 20 by removing the eye washing nozzle 10. By replenishing the eye washing liquid 30 in this way, the eye washing nozzle 10 and the container body portion 20 can be used repeatedly, which is economical.

The eye washing nozzle 10 can be attached to and detached from a PET bottle body portion. For this reason, it is possible to use a PET bottle body portion instead of the container body portion 20. For example, during an emergency, the eye washing nozzle 10 can be attached to a PET bottle body portion containing water, and thereby the water can be discharged from the discharging port 16 to wash an eye.

A female screw that screws onto a male screw on the spout 22 of the container body portion 20 and the spout of the PET bottle body portion is formed on the inner circumferential surface of the base portion 12. Accordingly, the eye washing nozzle 10, which can be attached to or detached from the container body portion 20 and the PET bottle body portion, can be realized with a simple configuration.

### Second Embodiment

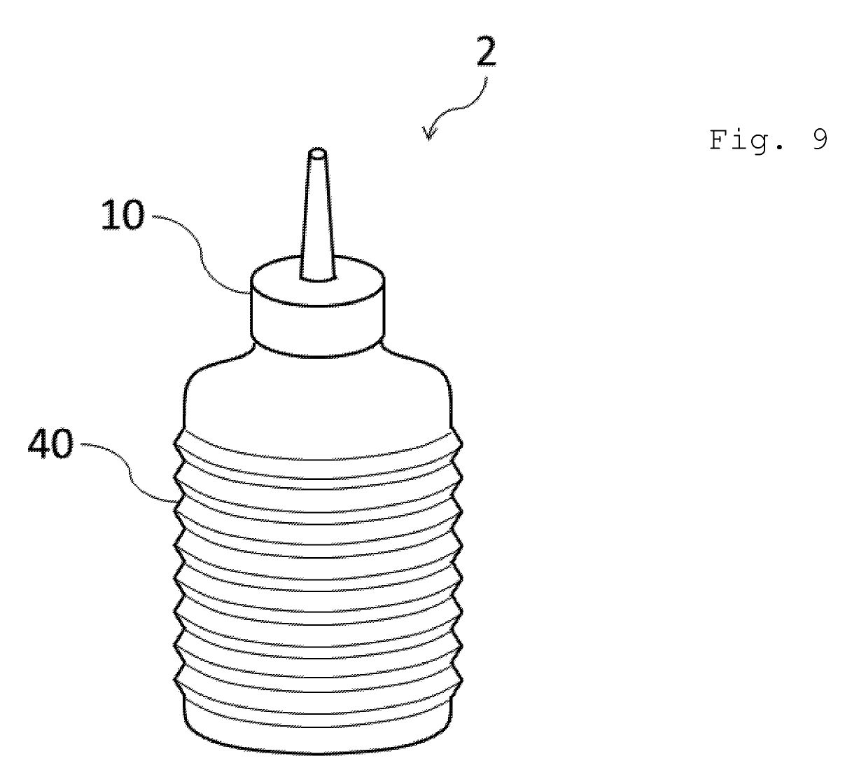

FIG. 9 is a perspective view showing a second embodiment of an eye washing liquid container according to the present invention. An eye washing liquid container 2 includes an eye washing nozzle 10 and a container body portion 40. The configuration of the eye washing nozzle 10 is the same as that described in the first embodiment. In the present embodiment, the eye washing nozzle 10 is attached to the container body portion 40. Eye washing liquid 30 (not shown in FIG. 9) is contained in the container body portion 40.

At least a portion of the side surface of the container body portion 40 is bellows-shaped. Accordingly, the container body portion 40 can contract in the height direction. When the height of the container body portion 40 in the non-contracted state is set to 1, the height of the container body portion 40 in the most contracted state is preferably 0.5 or less. Other configurations of the container body portion 40 are similar to those of the above-described container body portion 20.

Effects of the present embodiment will be described here. The container body portion 40 can contract in the height direction. For this reason, the eye washing liquid 30 can be discharged easily by pressing the bottom surface of the container body portion 40 with the hand, causing the container body portion 40 to contract in the height direction. Also, by changing the strength of the force of pressing, the degree with which the eye washing liquid 30 is discharged can be adjusted (see FIGS. 6 and 7).

At least a portion of the side surface of the container body portion 40 is bellows-shaped. Accordingly, a container body portion 40 that can contract in the height direction can be realized with a simple configuration.

By causing the container body portion 40 to contract significantly in the height direction, the eye washing liquid 30 can be discharged vigorously, and the eye washing effect can be increased. From this viewpoint, when the height of the container body portion 40 in the uncontracted state is set to 1, the height of the container body portion 40 in the most contracted state is preferably 0.5 or less. Other effects of the eye washing liquid container 2 are the same as those described in the first embodiment.

### Third Embodiment

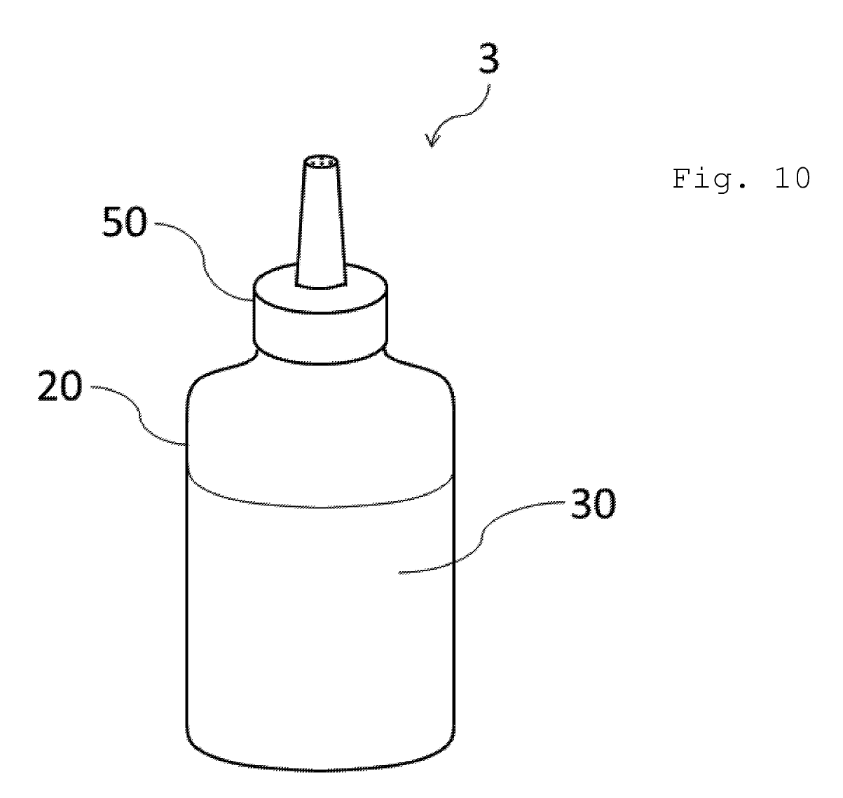

FIG. 10 is a perspective view showing a third embodiment of an eye washing liquid container according to the present invention. An eye washing liquid container 3 includes an eye washing nozzle 50 and a container body portion 20. The configuration of the container body portion 20 is the same as that described in the first embodiment. The eye washing nozzle 50 is attached to the container body portion 20.

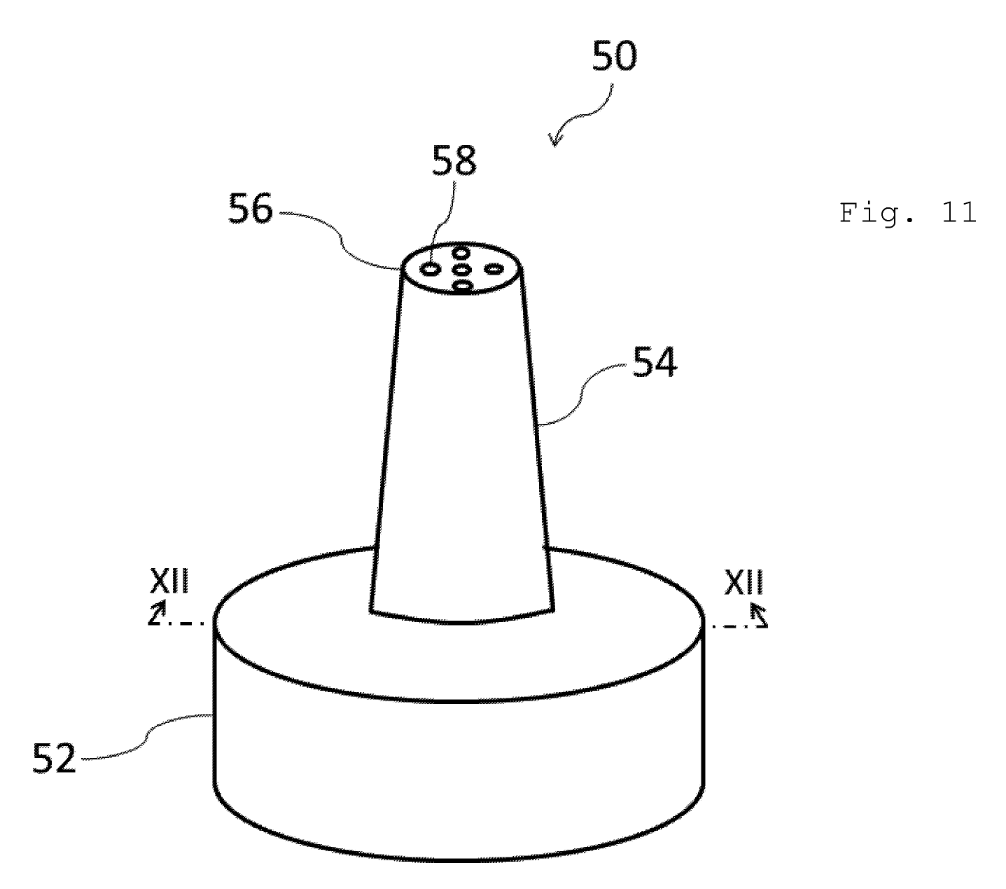

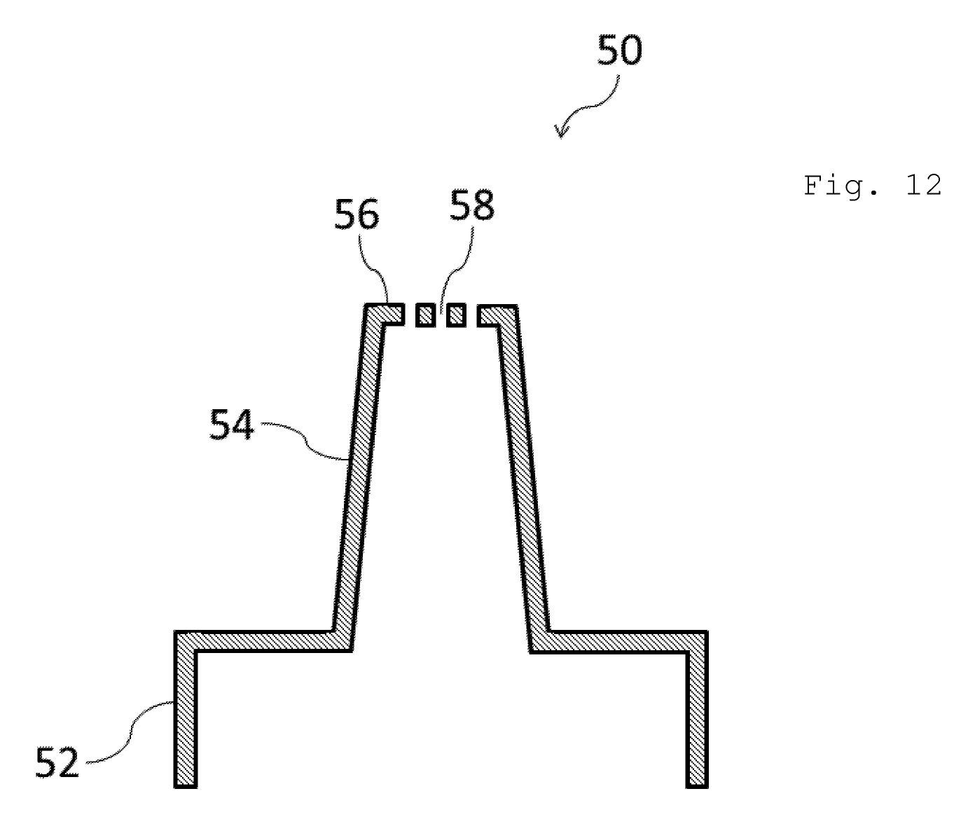

FIG. 11 is a perspective view showing the eye washing nozzle 50 in a state of having been removed from the container body portion 20. Also, FIG. 12 is an end view taken along line XII-XII in FIG. 11. The eye washing nozzle 50 includes a base portion 52 and a tubular portion 54. The structure of the base portion 52 is similar to that of the above-described base portion 12. The leading end portion of the tubular portion 54 is provided with a discharging port 56 for discharging the eye washing liquid 30 that has passed through the tubular portion 54.

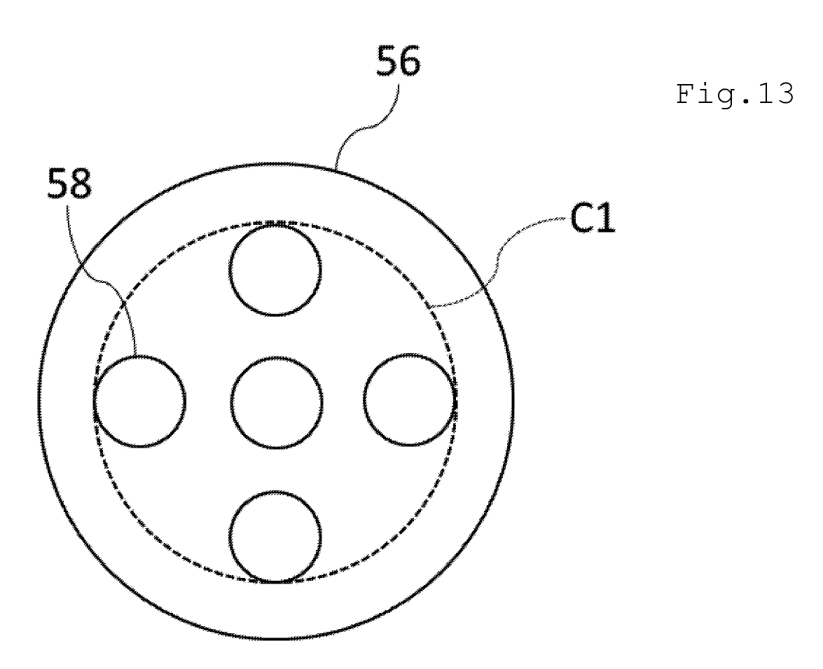

The discharging port 56 is composed of multiple hole portions 58, and the eye washing liquid 30 is discharged as a shower. In the present embodiment, five hole portions 58 are provided. The hole portions 58 are in communication with the one tubular portion 54, as can be understood from FIG. 12. Also, the hole portions 58 are provided so as to be located within a circular region with a diameter of 1 cm in plan view. In other words, as shown in the plan view in FIG. 13, when thought of as the smallest circle C1 that can contain all of the hole portions 58 constituting the discharging port 56, the diameter of the circle C1 is 1 cm or less.

Effects of the present embodiment will be described here. The discharging port 56 of the eye washing nozzle 50 is composed of the multiple hole portions 58, and discharges the eye washing liquid 30 as a shower. Accordingly, it is possible to wash a large region of the eye at one time.

The multiple hole portions 58 are in communication with the one tubular portion 54. Accordingly, the eye washing liquid 30 that has passed through the relatively wide flow path (tubular portion 54) can be discharged from the relatively narrow hole portions 58 all at once. Accordingly, the structure is appropriate for vigorously discharging the eye washing liquid 30 as a shower.

The multiple hole portions 58 constituting the discharging port 56 are provided so as to be located within a circular region with a diameter of 1 cm in plan view. Accordingly, it is possible to suppress a case in which the eye washing liquid 30 discharged as a shower spreads in the lateral direction more than is necessary. Accordingly, it is possible to prevent the eye washing liquid 30 from landing on a region other than the eye. Other effects of the eye washing liquid container 3 are the same as those described in the first embodiment.

The eye washing nozzle and the eye washing liquid container according to the present invention are not limited to the above-described embodiments, and various modifications are possible. In the above-described embodiments, an eye washing nozzle that is detachable from a container body portion was given as an example. However, the eye washing nozzle may be attached such that it is not detachable from the container body portion.

In the above-described embodiments, a tubular portion with a tapered shape having an inner radius that decreases toward the discharging port was given as an example. However, the tubular portion may have a tapered shape with an inner radius that increases toward the discharging port, or may have a tubular shape with an approximately constant inner radius.

### LIST OF REFERENCE SIGNS

1 Eye washing liquid container
2 Eye washing liquid container
3 Eye washing liquid container
10 Eye washing nozzle
12 Base portion
14 Tubular portion
16 Discharging port
20 Container body portion
22 Spout
30 Eye washing liquid
40 Container body portion
50 Eye washing nozzle
52 Base portion
54 Tubular portion
56 Discharging port
58 Hole portion
90 Eye

1. An eye washing nozzle to be attached to a container body portion for containing eye washing liquid, comprising:
a base portion to be fixed to the container body portion; and
a tubular portion that is connected to the base portion and through which the eye washing liquid passes,
wherein a leading end portion of the tubular portion is provided with a discharging port for discharging the eye washing liquid that has passed through the tubular portion.

2. The eye washing nozzle according to claim 1, wherein
an amount of the eye washing liquid discharged from the discharging port in one instance is greater than 0.03 ml.

3. The eye washing nozzle according to claim 2, wherein
the amount of the eye washing liquid discharged from the discharging port in one instance is greater than 0.15 ml.

4. The eye washing nozzle according to claim 1, wherein
the eye washing nozzle is detachable from the container body portion.

5. The eye washing nozzle according to claim 4, wherein
the eye washing nozzle can be attached to and detached from a PET bottle body portion.

6. The eye washing nozzle according to claim 5, wherein
the base portion is ring-shaped, and
a female screw that screws onto a male screw formed at a spout of the PET bottle body portion is formed on an inner circumferential surface of the base portion.

7. The eye washing nozzle according to claim 1, wherein
the tubular portion has a tapered shape with an inner diameter that decreases toward the discharging port.

8. The eye washing nozzle according to claim 1, wherein
the discharging port is composed of a plurality of hole portions and discharges the eye washing liquid as a shower.

9. The eye washing nozzle according to claim 8, wherein
the plurality of hole portions are in communication with the one tubular portion.

10. The eye washing nozzle according to claim 8, wherein
the plurality of hole portions constituting the discharging port are provided so as to be located within a circular region with a diameter of 1 cm in plan view.

11. An eye washing liquid container comprising:
the eye washing nozzle according to claim 1; and
the container body portion to which the eye washing nozzle is attached.

12. The eye washing liquid container according to claim 11, wherein
the volume of the container body portion is 50 ml or more.

13. The eye washing liquid container according to claim 11, wherein
the container body portion can be elastically deformed until opposing side surfaces thereof come into contact with each other.

14. The eye washing liquid container according to claim 11, wherein
the container body portion can contract in a height direction.

15. The eye washing liquid container according to claim 14, wherein
at least a portion of a side surface of the container body portion is bellows-shaped.

16. The eye washing liquid container according to claim 14, wherein
when the height of the container body portion in an uncontracted state is set to 1, the height of the container body portion in the most contracted state is 0.5 or less.

17. The eye washing liquid container according to claim 11, wherein
the eye washing liquid is discharged up to a height of 3 cm or more from the discharging port of the eye washing nozzle due to the container body portion being pressed.
